(19) United States
(12) Patent Application Publication
(10) Pub. No.: US 2024/0171995 A1
(43) Pub. Date: May 23, 2024

(54) BASE STATION DEVICE, TERMINAL DEVICE, WIRELESS COMMUNICATION SYSTEM, AND WIRELESS COMMUNICATION METHOD

(71) Applicant: FUJITSU LIMITED, Kawasaki-shi Kanagawa (JP)

(72) Inventor: YOSHIHIRO KAWASAKI, Kawasaki (JP)

(73) Assignee: FUJITSU LIMITED, Kawasaki-shi Kanagawa (JP)

(21) Appl. No.: 18/426,603

(22) Filed: Jan. 30, 2024

Related U.S. Application Data
(63) Continuation of application No. PCT/JP2021/035188, filed on Sep. 24, 2021.

(51) Int. Cl. H04W 16/28

(52) U.S. Cl. CPC H04W 16/28

(57) ABSTRACT

A base station device includes processor circuitry configured to generate a first-type pilot signal and a plurality of second-type pilot signals, multiply the first-type pilot signal by a first-type antenna weight, and multiply the plurality of second-type pilot signals by a second-type antenna weight, and a wireless transmitter configured to transmit the first-type pilot signal and the plurality of second-type pilot signals.

### CROSS-REFERENCE TO RELATED APPLICATION

This application is a continuation of International Application No. PCT/JP2021/035188, filed on Sep. 24, 2021, the entire contents of which are incorporated herein by reference.

### FIELD

The embodiment discussed herein is related to a base station device, a terminal device, a wireless communication system, and a wireless communication method.

### BACKGROUND

At present, as one of the technologies related to the wireless communication intended for sixth-generation mobile communication systems, the reconfigurable intelligent surface (RIS) technology is available. A reconfigurable intelligent surface represents a variable angle reflecting plate that is built by arranging a large number of RIS elements, which are configured using variable-capacitance diodes, in a two-dimensional manner on a dielectric surface at intervals equal to or smaller than the half wavelength. According to the RIS technology, the voltage applied to the RIS elements is varied, so that the angle of reflection of the wireless waves from the RIS can be varied.

When the direction of propagation of wireless signals transmitted from a base station device is varied using such a reconfigurable intelligent surface; not only the condition becomes suitable for large-volume data transfer, but the direction of propagation of superhigh frequency band wireless signals having a high degree of straightness can also be adjusted. Thus, for example, even for a terminal device which is so positioned that the reception of wireless signals from a base station device becomes difficult due to obstacles, the wireless signals reflecting from a reconfigurable intelligent surface can be received and large-volume data transfer using superhigh frequency band wireless signals can be achieved.
(Patent Literature 1) Japanese National Publication of International Patent Application No. 2015-530018
(Patent Literature 2) Japanese Laid-open Patent Publication No. 2009-153095

### SUMMARY

According to an aspect of an embodiment, a base station device includes a processor configured to generate a first-type pilot signal and a plurality of second-type pilot signals, multiply the first-type pilot signal by a first-type antenna weight, and multiply the plurality of second-type pilot signals by a second-type antenna weight, and a wireless transmitter configured to transmit the first-type pilot signal and the plurality of second-type pilot signals.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an exemplary configuration of a wireless communication system according to an embodiment;

FIG. 2 is a block diagram illustrating a configuration of a reconfigurable intelligent surface (RIS);

FIG. 3 is a block diagram illustrating a configuration of a base station device according to the embodiment;

FIG. 4 is a block diagram illustrating a configuration of a pilot signal generating unit;

FIG. 5 is a block diagram illustrating a configuration of a terminal device according to the embodiment;

FIG. 6 is a sequence diagram for explaining a wireless communication method implemented according to the embodiment;

FIG. 7 is a diagram illustrating a specific example of pilot signals;

FIG. 8 is a diagram illustrating a specific example of transmission timings of pilot signals; and

FIG. 9 is a block diagram illustrating a modification example of the pilot signal generating unit.

### DESCRIPTION OF EMBODIMENT

However, in regard to introducing the RIS technology in a wireless communication system, there are no case studies about the method for deciding on whether it is better if a base station device and a terminal device communicate directly with each other without involving the reconfigurable intelligent surface, or it is better if a base station and a terminal device perform communication via a reconfigurable intelligent surface. Moreover, when a base station device and a terminal device are to communicate with each other via a reconfigurable intelligent surface, the method for deciding on the appropriate angle of reflection in the reconfigurable intelligent surface has not been given consideration. Hence, even if the RIS technology is introduced in a wireless communication system, the direction of propagation of the wireless signals does not get adjusted in an appropriate manner, and the quality of wireless communication is difficult to improve.

Preferred embodiments will be explained with reference to accompanying drawings. However, the present embodiment is not limited by the embodiment described below.

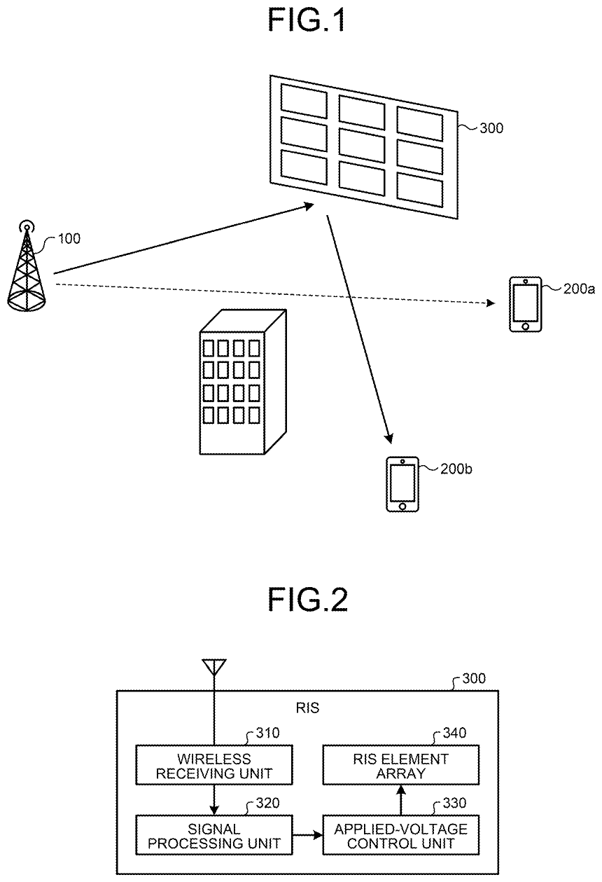

FIG. 1 is a diagram illustrating an exemplary configuration of the wireless communication system according to the embodiment. The wireless communication system illustrated in FIG. 1 includes a base station device 100, terminal devices 200a and 200b, and a reconfigurable intelligent surface (RIS) 300.

The base station device 100 performs wireless communication with the terminal devices 200a and 200b. At that time, the base station device 100 determines whether or not the wireless communication with the terminal device 200a and the terminal device 200b is to be performed via the RIS 300, and transmits wireless signals to the terminal devices 200a and 200b according to the respective determination results. In the example illustrated in FIG. 1, the base station device 100 transmits wireless signals directly to the terminal device 200a, and transmits wireless signals to the terminal device 200b via the RIS 300. Herein, it is illustrated that an obstacle is present between the base station device 100 and the terminal device 200b. Hence, the superhigh frequency band wireless signals having a high degree of straightness are not propagated from the base station device 100 to the terminal device 200b. For that reason, the base station device 100 ensures that the wireless signals are reflected from the RIS 300 toward the terminal device 200b.

The base station device 100 transmits a normal pilot signal and a pilot signal meant for deciding on the transmission method, and accordingly decides on the transmission methods with respect to the terminal devices 200a and 200b. Herein, for each angle of reflection in the RIS 300, the base station device 100 transmits a different pilot signal as the pilot signal meant for deciding on the transmission method. Then, the base station device 100 receives reports about the received power in the terminal devices 200a and 200b regarding the normal pilot signal and regarding the pilot signal corresponding to each angle of reflection in the RIS 300, and decides on whether or not to transmit the wireless signals via the RIS 300 to the terminal device 200a and the terminal device 200b. Moreover, in the case of transmitting the wireless signals via the RIS 300, the base station device 100 decides on the appropriate angle of reflection in the RIS 300 according to the received power regarding the pilot signal corresponding to each angle of reflection.

The terminal devices 200a and 200b perform wireless communication with the base station device 100 either in a direct manner or via the RIS 300. The terminal devices 200a and 200b receive pilot signals transmitted from the base station device 100, and measure the respective received power. At that time, the terminal device 200a as well as the terminal device 200b receives a different pilot signal corresponding to each angle of reflection in the RIS 300, and measures the received power regarding the pilot signal corresponding to each angle of reflection. Then, the terminal device 200a as well as the terminal device 200b identifies the pilot signal corresponding to the maximum received power, and reports the information regarding the maximum received power to the base station device 100.

The RIS 300 is a variable angle reflecting plate that is built by arranging a large number of RIS elements in a two-dimensional manner on a dielectric surface. The RIS 300 receives the wireless signals transmitted from the base station device 100, controls the voltage applied to the RIS elements according to the received wireless signals, and varies the angle of reflection for those wireless signals. That is, under the control of the base station device 100, the RIS 300 varies the angle of reflection for the wireless signals, and reflects the pilot signals, each of which corresponds to a different angle of reflection, according to the respective angles of reflection.

FIG. 2 is a block diagram illustrating a configuration of the RIS 300. The RIS 300 illustrated in FIG. 2 includes a wireless receiving unit 310, a signal processing unit 320, an applied-voltage control unit 330, and an RIS element array 340.

The wireless receiving unit 310 receives the wireless signals that are transmitted from the base station device 100. More particularly, the wireless receiving unit 310 receives control signals meant for controlling the angles of reflection for the wireless signals in the RIS 300. Regarding the control signals, for example, it is possible to use pilot signals having different patterns according to the measure of the angles of reflection. That is, the wireless receiving unit 310 receives, from the base station device 100, a different pilot signal corresponding to each angle of reflection.

The signal processing unit 320 obtains a control signal, which is meant to control the angle of reflection, from the signals received by the wireless receiving unit 310. More particularly, the signal processing unit 320 detects a pilot signal coming from the base station device 100, and identifies the control details regarding the angle of reflection according to the pilot signal. Then, the signal processing unit 320 notifies the applied-voltage control unit 330 of the identified control details.

According to the control details regarding the angle of reflection as notified from the signal processing unit 320, the applied-voltage control unit 330 controls the voltage to be applied to the RIS element array 340. That is, the applied-voltage control unit 330 applies such a voltage to the RIS element array 340 that the angle of reflection is set according to the pilot signal.

The RIS element array 340 represents a plurality of RIS elements arranged in a two-dimensional manner on the outer surface of the RIS 300. Thus, the RIS element array 340 includes a plurality of RIS elements each of which is configured using a variable-capacitance diode. Depending on the voltage applied to the RIS elements by the applied-voltage control unit 330, the RIS element array 340 varies the angle of reflection for the wireless signals in the RIS 300.

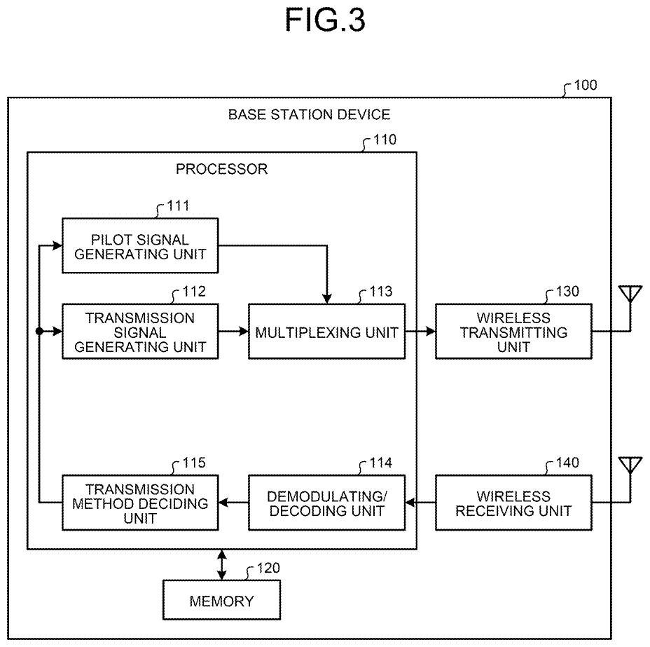

FIG. 3 is a block diagram illustrating a configuration of the base station device 100 according to the embodiment. The base station device 100 illustrated in FIG. 3 includes a processor 110, a memory 120, a wireless transmitting unit 130, and a wireless receiving unit 140.

The processor 110 includes, for example, a central processing unit (CPU), a field programmable gate array (FPGA), or a digital signal processor (DSP), and performs comprehensive control of the entire base station device 100. More particularly, the processor 110 includes a pilot signal generating unit 111, a transmission signal generating unit 112, a multiplexing unit 113, a demodulating/decoding unit 114, and a transmission method deciding unit 115.

The pilot signal generating unit 111 generates, from a predetermined code sequence, pilot signals that are also known to the terminal devices 200a and 200b. At that time, the pilot signal generating unit 111 generates two types of pilot signals to be transmitted in different directions. More particularly, the pilot signal generating unit 111 generates a first-type pilot signal that is directly transmitted in the directions of the terminal devices 200a and 200b, and generates second-type pilot signals that are transmitted in the direction of the RIS 300. That is, the pilot signal generating unit 111 multiplies the first-type pilot signal by a first-type antenna weight, which corresponds to the directions of the terminal devices 200a and 200b; and multiplies the second-type pilot signals by a second-type antenna weight, which corresponds to the direction of the RIS 300. Moreover, at the time of generating the second-type pilot signals, the pilot signal generating unit 111 performs cyclic shifting of a predetermined code sequence and generates a different second-type pilot signal corresponding to each angle of reflection in the RIS 300. Regarding a specific configuration of the pilot signal generating unit 111, the detailed explanation is given later.

The transmission signal generating unit 112 generates transmission signals from control information and transmission data. That is, the transmission signal generating unit 112 encodes and modulates the control information and the transmission data, and generates transmission signals to be transmitted to the terminal devices 200a and 200b. Moreover, the transmission signal generating unit 112 assigns (multiplies) an antenna weight to each transmission signal to be transmitted to the terminal devices 200a and 200b, and thus implements beam forming. At that time, according to the transmission direction of a transmission signal, the transmission signal generating unit 112 multiplies the transmission signal by either the first-type antenna weight or the second-type antenna weight. That is, when transmission signals intended for the terminal devices 200a and 200b are to be transmitted in the directions of the terminal devices 200a and 200b according to an instruction from the transmission method deciding unit 115, the transmission signal generating unit 112 multiplies the transmission signals by the first-type antenna weight. On the other hand, when transmission signals are to be transmitted in the direction of the RIS 300, the transmission signal generating unit 112 multiplies the transmission signals by the second-type antenna weight. In this way, beam forming is implemented.

The multiplexing unit 113 performs time multiplexing and frequency multiplexing with respect to the pilot signals generated by the pilot signal generating unit 111 and with respect to the transmission signals generated by the transmission signal generating unit 112. Then, the multiplexing unit 113 outputs multiplexed signals, which are obtained as a result of performing multiplexing with respect to the pilot signals and the transmission signals, to the wireless transmitting unit 130.

The demodulating/decoding unit 114 obtains the received signals from the wireless receiving unit 140, and demodulates and decodes the received signals. Then, the demodulating/decoding unit 114 obtains report information that originated from the terminal devices 200a and 200b and that is included in the received signals, and outputs the report information to the transmission method deciding unit 115. The report information contains the information about the received power corresponding to the pilot signals as measured in the terminal devices 200a and 200b.

Based on the report information output from the demodulating/decoding unit 114, the transmission method deciding unit 115 decides on whether to transmit signals directly or via the RIS 300 to each of the terminal devices 200a and 200b. More particularly, regarding the terminal devices 200a and 200b in which the first-type pilot signal represents the pilot signal corresponding to the maximum received power, the transmission method deciding unit 115 decides to transmit signals directly. On the other hand, regarding the terminal devices 200a and 200b in which a second-type pilot signal represents the pilot signal corresponding to the maximum received power, the transmission method deciding unit 115 decides to transmit signals via the RIS 300. Moreover, when a second-type pilot signal represents the pilot signal corresponding to the maximum received power, the transmission method deciding unit 115 identifies the angle of reflection in the RIS 300 corresponding to the amount of cyclic shift in the concerned second-type pilot signal.

Then, the transmission method deciding unit 115 notifies the pilot signal generating unit 111 and the transmission signal generating unit 112 about the information indicating whether the signals are to be transmitted directly or via the RIS 300 to the terminal device 200a and to the terminal device 200b. That is, the transmission method deciding unit 115 instructs the pilot signal generating unit 111 and the transmission signal generating unit 112 about whether to transmit the signals in the directions of the terminal devices 200a and 200b or in the direction of the RIS 300. Moreover, if the signals are to be transmitted via the RIS 300, then the transmission method deciding unit 115 notifies the pilot signal generating unit 111 about the information indicating the amount of cyclic shift in the second-type pilot signal corresponding to the maximum received power.

The memory 120 includes, for example, a random access memory (RAM) or a read only memory (ROM), and is used to store the information used in the processing performed by the processor 110.

The wireless transmitting unit 130 performs predetermined wireless transmission processing with respect to the multiplexed signals output from the multiplexing unit 113, and performs wireless transmission via an antenna.

The wireless receiving unit 140 receives signals via an antenna and performs predetermined wireless reception processing with respect to the received signals. Then, the wireless receiving unit 140 outputs the received signals to the demodulating/decoding unit 114.

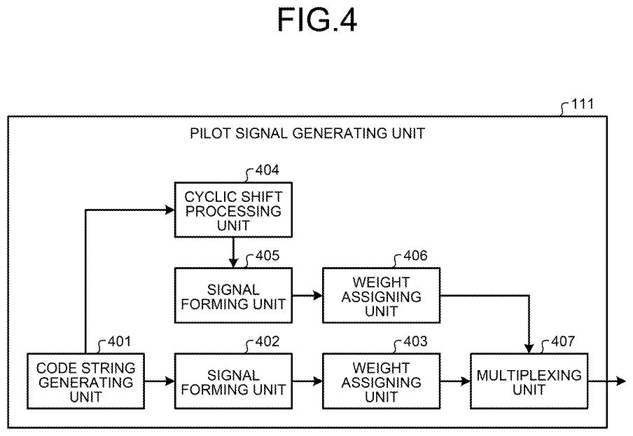

FIG. 4 is a block diagram illustrating a configuration of the pilot signal generating unit 111. The pilot signal generating unit 111 illustrated in FIG. 4 includes a code sequence generating unit 401, a signal forming unit 402, a weight assigning unit 403, a cyclic shift processing unit 404, a signal forming unit 405, a weight assigning unit 406, and a multiplexing unit 407.

The code sequence generating unit 401 generates a code sequence to be used in generating pilot signals. The code sequence generated by the code sequence generating unit 401 is also known to the terminal devices 200a and 200b. The code sequence generating unit 401 outputs the code sequence to the signal forming unit 402 and the cyclic shift processing unit 404.

The signal forming unit 402 uses the code sequence and forms a first-type pilot signal to be transmitted directly in the directions of the terminal devices 200a and 200b.

The weight assigning unit 403 assigns (multiplies) the first-type antenna weight, which is used in forming beams directed toward the terminal devices 200a and 200b, to the first-type pilot signal.

The cyclic shift processing unit 404 performs cyclic shifting of the code sequence. More particularly, the cyclic shift processing unit 404 cyclically shifts the bits constituting the code sequence, and generates a plurality of code sequences having different amounts of cyclic shift. The amounts of cyclic shift of such code sequences correspond on a one-on-one basis with the angles of reflection in the RIS 300. That is, a plurality of code sequences, which is generated by the cyclic shift processing unit 404 by performing cyclic shifting, corresponds to mutually different angles of reflection in the RIS 300. Meanwhile, when the amount of cyclic shift of the second-type pilot signal corresponding to the maximum received power is notified by the transmission method deciding unit 115, the cyclic shift processing unit 404 generates code sequences by performing cyclic shifting according to the notified amount of cyclic shift.

The signal forming unit 405 uses the code sequences, which are obtained by the cyclic shift processing unit 404 by performing cyclic shifting, and forms second-type pilot signals to be transmitted in the direction of the RIS 300. That is, from the code sequences corresponding to mutually different angles of reflection, the signal forming unit 405 forms second-type pilot signals corresponding to the angles of reflection.

The weight assigning unit 406 assigns (multiplies) the second-type antenna weight, which is used in forming beams directed toward the RIS 300, to the second-type pilot signals.

The multiplexing unit 407 performs time multiplexing and frequency multiplexing with respect to the first-type pilot signal and the second-type pilot signals. More particularly, for example, the multiplexing unit 407 performs time multiplexing with respect to the second-type pilot signals corresponding to mutually different amounts of cyclic shift, and performs frequency multiplexing with respect to the first-type pilot signal as well as the second-type pilot signals. Then, the multiplexing unit 407 outputs pilot signals including the first-type pilot signal and the second-type pilot signals to the multiplexing unit 113.

In this way, the pilot signal generating unit 111 generates pilot signals that include the first-type pilot signal transmitted in the directions of the terminal devices 200a and 200, and include a plurality of second-type pilot signals corresponding to mutually different amounts of cyclic shift and transmitted in the direction of the RIS 300.

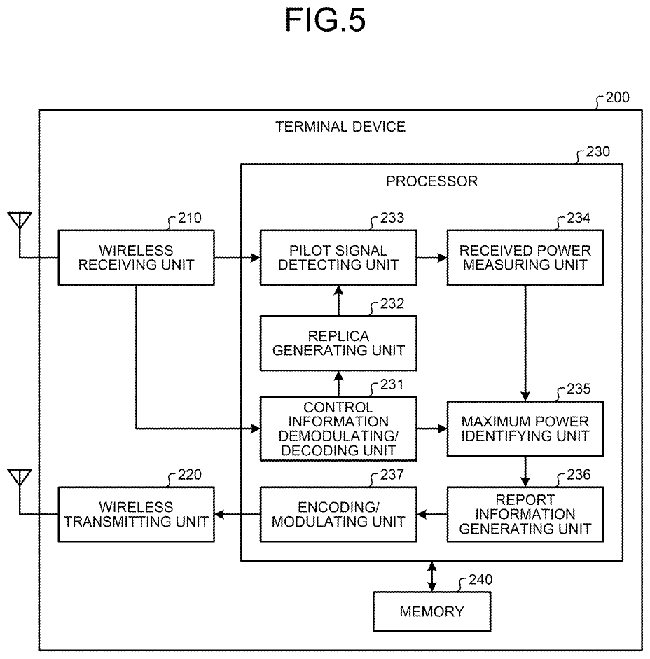

FIG. 5 is a block diagram illustrating a configuration of a terminal device 200 according to the embodiment. The terminal device 200 has an equivalent configuration to the configuration of the terminal devices 200a and 200b. The terminal device 200 illustrated in FIG. 5 includes a wireless receiving unit 210, a wireless transmitting unit 220, a processor 230, and a memory 240.

The wireless receiving unit 210 receives, via an antenna, the wireless signals transmitted from the base station device 100, and performs predetermined wireless reception processing with respect to the received signals. Then, the wireless receiving unit 210 outputs the received signals to the processor 230.

The wireless transmitting unit 220 performs predetermined wireless transmission processing with respect to the signals output from the processor 230, and performs wireless transmission via an antenna.

The processor 230 includes, for example, a CPU, an FPGA, or a DSP, and performs comprehensive control of the entire terminal device 200. More particularly, the processor 230 includes a control information demodulating/decoding unit 231, a replica generating unit 232, a pilot signal detecting unit 233, a received power measuring unit 234, a maximum power identifying unit 235, a report information generating unit 236, and an encoding/modulating unit 237.

The control information demodulating/decoding unit 231 demodulates and decodes the received signals, and obtains control information specified in the received signals. The control information contains the information about the code sequence used in generating pilot signals, and contains the information about the timings of transmission of the first-type pilot signal and the second-type pilot signals.

Based on the control information, the replica generating unit 232 generates replicas of the first-type pilot signal and the second-type pilot signals. More particularly, from the information about the code sequence as specified in the control information, the replica generating unit 232 generates replicas equivalent to the first-type pilot signal and the second-type pilot signals generated in the base station device 100. At that time, the replica generating unit 232 generates the replica of each second-type pilot signal corresponding to a different amount of cyclic shift.

The pilot signal detecting unit 233 uses the replicas generated by the replica generating unit 232, and detects the pilot signals from the received signals. For example, the pilot signal detecting unit 233 performs a correlation operation regarding the received signals and the replicas; and, from the received signals, detects the first-type pilot signal and detects the second-type pilot signals corresponding to mutually different amounts of cyclic shift.

The received power measuring unit 234 measures the received power of the first-type pilot signal and measures the received power of the second-type pilot signals corresponding to mutually different amounts of cyclic shift. Thus, the received power measuring unit 234 measures the received power of the first-type pilot signal that is received directly from the base station device 100, and measures the received power of the second-type pilot signals that are reflected at mutually different angles of reflection from the RIS 300.

The maximum power identifying unit 235 identifies the maximum received power from among the received power measured by the received power measuring unit 234. That is, the maximum power identifying unit 235 identifies the pilot signal corresponding to the maximum received power from among the first-type pilot signal and from among the second-type pilot signals corresponding to mutually different amounts of cyclic shift.

The report information generating unit 236 generates report information that contains the information about the received power regarding the first-type pilot signal and the received power regarding the second-type pilot signals corresponding to mutually different amounts of cyclic shifts, and contains the information enabling identification of the pilot signal corresponding to the maximum received power.

The encoding/modulating unit 237 encodes and modulates the report information generated by the report information generating unit 236, and uses the wireless transmitting unit 220 to transmit the report information to the base station device 100.

The memory 240 includes, for example, a RAM or a ROM, and is used to store the information used in the processing performed by the processor 230.

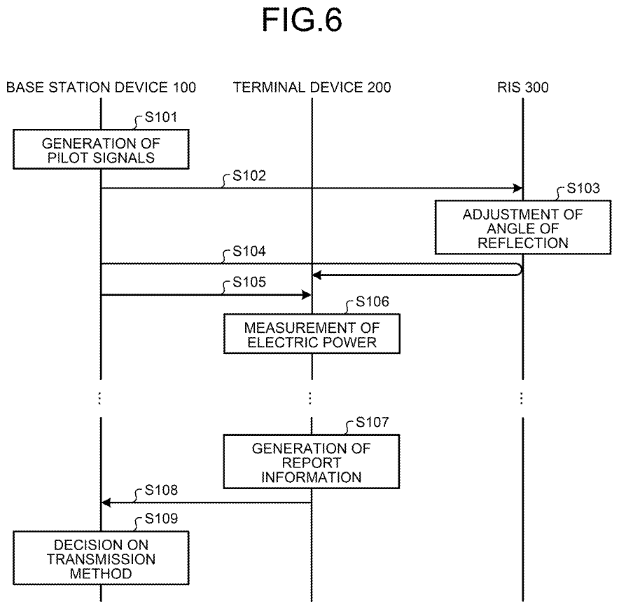

Explained below with reference to a sequence diagram illustrated in FIG. 6 is a wireless communication method implemented in the wireless communication system configured as explained above.

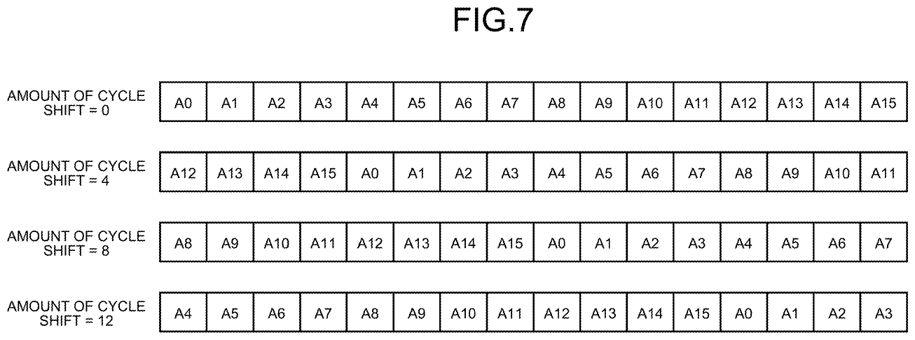

In the base station device 100, pilot signals are generated using a predetermined code sequence (Step S101). More particularly, a first-type pilot signal is generated from the code sequence, and a plurality of second-type signals is generated from code sequences that are obtained cyclic shifting according to mutually different amounts of cyclic shift. That is, for example, as illustrated in FIG. 7, a first-type pilot signal is generated from the code sequence having the amount of cyclic shift to be equal to “0”; and second-type pilot signals are generated from the code sequences having the amounts of cyclic shift equal to “4”, “8”, and “12”. In the example illustrated in FIG. 7, 16-bit code sequences are cyclically shifted by 4 bits at a time. For example, in the code sequence having the amount of cyclic shift equal to “4”, the last 4 bits A12 to A15 of the code sequence having the amount of cyclic shift equal to “0” are shifted to the front due to cyclic shifting. The amounts of cyclic shift correspond to the angles of reflection set in the RIS 300, and the second-type pilot signals that are generated from the code sequences having the amounts of cyclic shift “4”, “8”, and “12” correspond to mutually different angles of reflection.

After the first-type pilot signal and the second-type pilot signals are generated, a second-type pilot signal is transmitted to the RIS 300 (Step S102). Herein, the second-type pilot signal corresponding any one angle of reflection is transmitted and, once that second-type pilot signal is received by the RIS 300, the angle of reflection is set according to the amount of cyclic shift of that second-type pilot signal (Step S103). That is, in the RIS 300, according to the amount of cyclic shift of the received second-type pilot signal, the voltage to be applied to the RIS element array 340 is controlled and the angle of reflection for the wireless signals in the RIS 300 is adjusted. That is, the concerned second-type pilot signal functions as a control signal meant for controlling the angle of reflection in the RIS 300.

After the transmission of the concerned second-type pilot signal, an identical second-type pilot signal is transmitted to the RIS 300 (Step S104). In the RIS 300, since the angle of reflection has been adjusted, the identical second-type pilot signal reflects at the adjusted angle of reflection in the RIS 300. Moreover, at the same time of transmitting that second-type pilot signal, the first-type pilot signal is transmitted to the terminal device 200 (Step S105). That is, the transmission of the first-type pilot signal and the second round of transmission of the second-type pilot signal is carried out in a simultaneous manner.

The terminal device 200 receives the first-type pilot signal and receives the second-type pilot signal reflected from the RIS 300. Then, in the terminal device 200, the first-type pilot signal and the second-type pilot signal are detected from the received signals, and the received power regarding the first-type pilot signal and the second-type pilot signal is measured (Step S106).

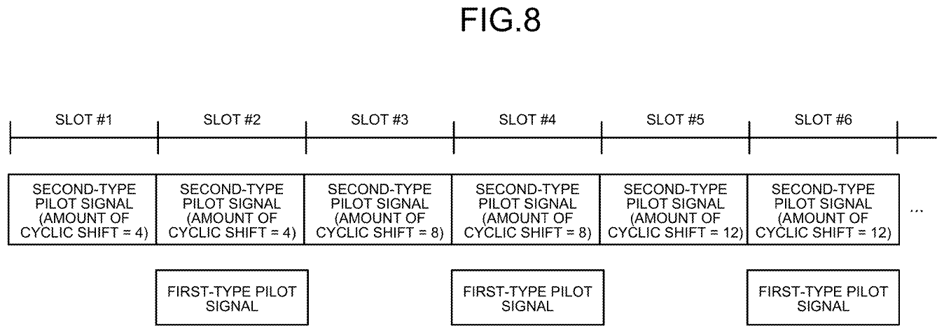

The transmission of a second-type pilot signal and the subsequent adjustment of the angle of reflection in the RIS 300 as performed from Step S102 to Step S106, as well as the measurement of the received power regarding the first-type pilot signal and the second-type pilot signal is performed in a repeated manner regarding each second-type pilot signal corresponding to a different amount of cyclic shift. That is, for example, as illustrated in FIG. 8, in each odd-numbered slot such as slots #1, #3, #5, and so on, a second-type pilot signal corresponding to a different amount of cyclic shift is sent as the control signal meant for adjusting the angle of reflection in the RIS 300. Moreover, in each even-numbered slot such as slots #2, #4, #6, and so on, a second-type pilot signal identical to the second-type pilot signal transmitted in the previous odd-numbered slot is transmitted, and the first-type pilot signal is also transmitted. The terminal device 200 receives the first-type pilot signal and a second-type pilot signal in each even-numbered slot, and measures the received power. As a result, in the terminal device 200, it becomes possible to measure the received power regarding the first-type pilot signal that is transmitted in the direction of the terminal device 200, and to measure the received power of a plurality of second-type pilot signals reflecting at mutually different angles of reflection in the RIS 300.

In the terminal device 200, after measuring the received power of the first-type pilot signal and the received power of a plurality of second-type pilot signals corresponding to mutually different amounts of cyclic shift, the pilot signal corresponding to the maximum received power is identified and report information is generated about the received power of the pilot signals and about the pilot signal corresponding to the maximum received power (Step S107). Then, the report information is sent to the base station device 100 (Step S108).

Upon receiving the report information, the base station device 100 decides on whether to transmit signals directly or via the RIS 300 to the terminal device 200 (Step S109). That is, when the first-type pilot signal corresponds to the maximum received power, it is decided that the signals are to be transmitted from the base station device 100 directly to the terminal device 200. On the other hand, when a second-type pilot signal corresponds to the maximum received power, it is decided that the signals transmitted from the base station device 100 are to be reflected from the RIS 300 toward the terminal device 200. Moreover, from the amount of cyclic shift of the second-type pilot signal corresponding to the maximum received power, the optimum angle of reflection in the RIS 300 is identified. That is, such an angle of reflection in the RIS 300 is identified corresponding to which the received power of the second-type pilot signal becomes the maximum. Then, the base station device 100 forms beams toward the decided direction and, in the case of performing transmission via the RIS 300, adjusts the angle of reflection in the RIS 300 to the optimum angle of reflection and performs wireless communication with the terminal device 200.

As explained above, according to the present embodiment, a base station device transmits a first-type pilot signal, which is to be transmitted directly in the direction of a terminal device, and transmits different second-type pilot signals corresponding to the angles of reflection in an RIS. Then, the base station device receives a report about the received power of the pilot signals in the terminal device, and decides on the transmission method according to the pilot signal corresponding to the maximum received power. For that reason, it becomes possible to appropriately decide whether to transmit the signals directly or via the RIS to the terminal device. Moreover, in the case of transmitting the signals via the RIS, it becomes possible to set the optimum angle of reflection in the RIS. That enables achieving enhancement in the wireless quality.

Meanwhile, in the embodiment described above, it is assumed that the first-type pilot signal and the second-type pilot signals are generated using the same code sequence. However, alternatively, the code sequence used in generating a first-type pilot signal can be different than the code sequence used in generating second-type pilot signals.

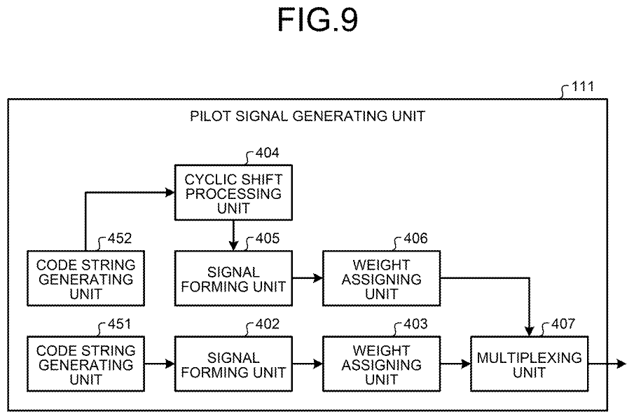

FIG. 9 is a block diagram illustrating a modification example of the pilot signal generating unit 111 of the base station device 100. In FIG. 9, the constituent elements identical to FIG. 4 are referred to by the same reference numerals, and their explanation is not given again. The pilot signal generating unit 111 illustrated in FIG. 9 includes code sequence generating units 451 and 452 in place of the code sequence generating unit 401 of the pilot signal generating unit illustrated in FIG. 4.

The code sequence generating unit 451 generates a code sequence to be used in generating a first-type pilot signal. The code sequence generated by the code sequence generating unit 451 is also known to the terminal devices 200a and 200b. The code sequence generating unit 451 outputs the code sequence to the signal forming unit 402.

The code sequence generating unit 452 generates a code sequence used in generating second-type pilot signals. The code sequence generated by the code sequence generating unit 452 is also known to the terminal devices 200a and 200b. The code sequence generating unit 452 outputs the code sequence to the cyclic shift processing unit 404.

The pilot signal generating unit 111 has the configuration illustrated in FIG. 9. Thus, the first-type pilot signal is generated using a different code sequence than the code sequence used in generating the second-type pilot signals. In this case too, the second-type pilot signals are generated by cyclically shifting the concerned code sequence by a different amount of cyclic shift for each angle of reflection in the RIS 300.

Meanwhile, in the embodiment described above, the second-type pilot signals are used as the control signals meant for controlling the angles of reflection in the RIS 300. However, it is not always necessary to use the second-type pilot signals as the control signals. That is, for example, with reference to FIG. 8, in each odd-numbered slot such as slots #1, #3, #5, and so on, a control signal meant for controlling the angle of reflection can be transmitted; and, in each even-numbered slot such as slots #2, #4, #6, and so on, the first-type pilot signal and a second-type pilot signal can be transmitted. In this case too, the terminal device 200 receives the first-type pilot signal and the second-type pilot signal from each even-numbered slot, and measures the received power.

According to an aspect of the base station device, the terminal device, the wireless communication system, and the wireless communication method according to the application concerned, it becomes possible to enhance the wireless quality.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A base station device comprising:
processor circuitry configured to:
generate a first-type pilot signal and a plurality of second-type pilot signals,
multiply the first-type pilot signal by a first-type antenna weight, and
multiply the plurality of second-type pilot signals by a second-type antenna weight; and
a wireless transmitter configured to transmit the first-type pilot signal and the plurality of second-type pilot signals.

2. The base station device according to claim 1, wherein the processor circuitry is configured to:
generate the first-type pilot signal using a code sequence, and
generate the plurality of second-type pilot signals by cyclically shifting the code sequence.

3. The base station device according to claim 1, wherein the processor circuitry is configured to:
generate the first-type pilot signal using a first-type code sequence, and
generate the plurality of second-type pilot signals by cyclically shifting a second-type code sequence.

4. The base station device according to claim 2, wherein the processor circuitry is configured to associate amount of the cyclic shift with details of signal processing performed by a device that receives the plurality of second-type pilot signals.

5. The base station device according to claim 3, wherein the processor circuitry is configured to associate amount of the cyclic shift with details of signal processing performed by a device that receives the plurality of second-type pilot signals.

6. The base station device according to claim 4, wherein the device includes a function of varying angle of reflection of a received wireless signal.

7. The base station device according to claim 5, wherein the device includes a function of varying angle of reflection of a received wireless signal.

8. The base station device according to claim 1, further including a wireless receiver configured to receive information about received power corresponding to the first-type pilot signal and the plurality of second-type pilot signals in a terminal device, wherein
the processor circuitry is configured to:
decide, based on information received by the wireless receiver, to use what transmission method for transmitting a wireless signal to the terminal device, and
direct the wireless transmitter to transmit the wireless signal according to the decided transmission method.

9. The base station device according to claim 8, wherein, when received power corresponding to the first-type pilot signal is maximum, the processor circuitry is configured to decide that the wireless signal for the terminal device is to be transmitted after the wireless signal is multiplied by the first-type antenna weight.

10. The base station device according to claim 8, wherein, when received power corresponding to one of the plurality of second-type pilot signals is maximum, the processor circuitry is configured to decide decides that the wireless signal for the terminal device is to be transmitted after the wireless signal is multiplied by the second-type antenna weight.

11. The base station device according to claim 8, wherein, when received power corresponding to one of the plurality of second-type pilot signals is maximum, the processor circuitry is configured to set details of signal processing which are associated to second-type pilot signal corresponding to maximum received power.

12. A terminal device comprising:
a wireless receiver configured to receive a first-type pilot signal and a plurality of second-type pilot signals;
processor circuitry configured to measure received power corresponding to the first-type pilot signal and the plurality of second-type pilot signals; and
a wireless transmitter configured to transmit report information, which is generated by the processor circuitry, to a base station device.

13. A wireless communication system comprising:
a base station device;
a terminal device configured to perform wireless communication with the base station device; and
a device configured to include a function of varying angle of reflection of a wireless signal, wherein
the base station device includes:
first-type processor circuitry configured to generate a first-type pilot signal and a plurality of second-type pilot signals, and
a first-type wireless transmitter configured to transmit the first-type pilot signal in direction of the terminal device and transmit the plurality of second-type pilot signals in direction of the device, and
the terminal device includes:
a wireless receiver configured to receive the first-type pilot signal and the plurality of second-type pilot signals,
second-type processor circuitry configured to measure received power corresponding to the first-type pilot signal and the plurality of second-type pilot signals, and generate report information containing measurement result of received power, and
a second-type wireless transmitter configured to transmit report information, which is generated by the second-type processor circuitry, to the base station device.

14. A wireless communication method that is implemented in a wireless communication system which comprises:
a base station device,
a terminal device configured to perform wireless communication with the base station device, and
a device configured to have a function of varying angle of reflection of a wireless signal,
the wireless communication method including:
generating, by the base station device, a first-type pilot signal and a plurality of second-type pilot signals; and
transmitting, by the base station device, the first-type pilot signal in direction of the terminal device and transmitting the plurality of second-type pilot signals in direction of the device;
receiving, by the terminal device, the first-type pilot signal and the plurality of second-type pilot signals;
measuring, by the terminal device, the received power corresponding to the first-type pilot signal and the plurality of second-type pilot signals;
generating, by the terminal device, report information containing measurement result of received power; and
transmitting, by the terminal device, the report information to the base station device.
